(19) United States
(12) Patent Application Publication
(10) Pub. No.: US 2007/0042696 A1
(43) Pub. Date: Feb. 22, 2007

(54) Modular desktop-type ventilation system

(76) Inventor: Gary M. Casey, East Amherst, NY (US)

Correspondence Address: SIMPSON & SIMPSON, PLLC, 5555 MAIN STREET, WILLIAMSVILLE, NY, 14221-5406, US

(21) Appl. No.: 11/391,101

(22) Filed: Mar. 28, 2006

Related U.S. Application Data
(63) Continuation-in-part of application No. 11/013,169, filed on Dec. 15, 2004.
(60) Provisional application No. 60/665,895, filed on Mar. 28, 2005.

(51) Int. Cl. B08B 15/00

(52) U.S. Cl. 454/49

(57) ABSTRACT

A desktop-type ventilation system generally including a ventilation hub comprising at least one vent and at least one fume hood work station. The fume hood comprises at least two side walls detachably connected to the ventilation hub and at least one top wall detachably connected to the side walls. The side walls and the top wall disposed at an angle to funnel air toward the vent. In one embodiment the front wall defines a work area inlet and the front wall is detachably connected to the side walls. A rear wall is defined by the face of said ventilation hub which comprises an outlet orifice. The ventilation hub can further comprises a self contained air purifying system, lights mounted at an angle of inclination similar to that of the top walls, and at least one electronic display that can have a membrane control pad or mouse.

### CROSS-REFERENCE TO RELATED APPLICATIONS

This application is a continuation-in-part application of U.S. application Ser. No. 11/013,169, filed Dec. 15, 2004, which application is incorporated herein by reference. This application also claims benefit of U.S. Provisional Application No. 60/665,895, filed Mar. 28, 2005.

### FIELD OF THE INVENTION

The present invention relates to ventilation systems, and more particularly, to an improved modular desktop-type ventilation system.

### BACKGROUND OF THE INVENTION

Fume hoods for removing fumes, vapors, potentially harmful gases, and particulates, etc., from laboratories, work areas and instructional type settings are fairly well known. Currently, most fume hoods comprise large, cabinet-type structures that are typically anchored in place. An example of an anchored type fume hood is generally disclosed in U.S. Pat. No. 6,080,058. Anchored type fume hoods generally comprise a plurality of flat, rectangular walls that form rectangular parallelepipeds. The front walls of these types of fume hood typically comprise a planar sash that may be raised and lowered to allow access to a work area. Typically, an area of low pressure is created within the cabinet structure by means of a fixed ventilation system, which draws air into the fume hood and evacuates any contaminated air out of the work area.

A problem with anchored fume hoods is that they are large, noisy, non-movable, obstructive and expensive. Because of their large size, anchored fume hoods are usually fixed in place and/or are placed in out of the way locations within laboratories or classrooms. This can be problematic when laboratory or classroom instruction is required. For example, it can be difficult to assemble several individuals around an anchored fume hood in order to provide proper instruction. Also, the large size of the anchored fume hoods can block individuals' fields of vision/lines of sight during regular classroom instruction. Moreover, the interior rear baffle slot velocities are excessively high in anchored fume hoods to effectively remove air from the work area; the high air velocities typically create unwanted noise and unnecessary turbulence at typically higher than acceptable air speeds for many fume hood techniques. Additionally, because of their size and expense, only a limited number of anchored fume hoods may be affordable or be capable of being conveniently placed within a typical laboratory or classroom setting. As a result, the size and expense of anchored fume hoods can have the effect of limiting the number of individuals that may be safely present within a laboratory or classroom. While argument exists that it may be desirous to limit laboratory or class size and utilize large anchored fume hoods when extremely dangerous substances are used, in many instances, anchored fume hoods simply are not required and limiting class sizes in most facilities is not an economically viable solution or even practical given physical facility constraints. As a result, more compact, desktop-type fume hoods have been developed.

Current desktop-type fume hoods generally resemble anchored fume hoods in that they typically comprise a plurality of rectangular walls that form rectangular parallelepipeds; however, such devices are generally smaller and are capable of being placed on laboratory benches or desktops. The front walls of such compact desktop-type fume hoods typically comprise planar sashes that may be raised and lowered to allow access to a work area under the hood. The rectangular footprint of these fume hoods can make it difficult, from ergonomic standpoints, for individuals to work under the fume hood and/or they tend to limit and obstruct the transfer of data and services from one area to another in the student work area. Additionally, the rectangular configuration of the fume hood tends to produce inefficient airflow into and out of the fume hood. Moreover, in many instances, such fume hoods are formed from plastics or other materials that may be highly reactive with several chemicals commonly used in laboratories. The materials used to construct such fume hoods may also be prone to catching fire. Additionally, such compact, desktop-type fume hoods require separate ventilation ducts, or filtering devices, for each fume hood. Furthermore, known compact, desktop-type fume hoods cannot be broken down into smaller components and stored as flat panels after use in order to save storage space. Neither can current fume hoods be adjusted to suit a myriad of experiments or different sized users.

Additionally, a problem in many educational laboratory settings is that during laboratory experimentation, students may have problems completing a laboratory experiment, may have questions regarding an experiment, and/or some students may require additional support or guidance. Consequently, it can be difficult for a laboratory instructor to provide individual instruction to several individuals in the laboratory at the same time. Moreover, students may not work at a similar pace, thus, those whom work quickly may often have to wait for other individuals to complete a specific task before resuming experimentation.

Finally, in some instances laboratories may not comprise central ventilation systems to connect a fume hood and/or, if provided, such central HVAC systems can degrade over time rendering the central ventilation system insufficient for adequately exhausting contaminated air from a laboratory, or capable of reintroducing air into a laboratory. Consequently, it can be costly to install a central ventilation system or to maintain such central ventilation systems.

What is needed then is an adjustable and detachable desktop-type ventilation system that overcomes these, and other, disadvantages.

### SUMMARY OF THE INVENTION

The present invention comprises a desktop-type ventilation system generally including a ventilation hub comprising at least one vent and at least one fume hood work station. The fume hood comprises at least two side walls detachably connected to the ventilation hub and at least one top wall detachably connected to the side walls. The side walls and the top wall are disposed at an angle to funnel air toward the vent. In one embodiment, the front wall defines a work area inlet and the front wall is detachably connected to the side walls. A rear wall is defined by the face of said ventilation hub which comprises an outlet orifice.

In some embodiments, the front wall is arcuate and the arcuate surface has a radius on a top edge of said front wall that is smaller than a radius of a lower edge of said front wall such that said front wall slopes outward from said top edge to said lower edge. The ventilation hub can further comprise at least one adjustable track wherein said side walls and said top wall are adjustably connected to the ventilation hub. The ventilation hub can further comprise at least one internal channel, wherein plumbing, electric, and data lines are inside and fixtures for said plumbing, electric and data lines are disposed on the exterior of the ventilation hub.

In one embodiment, the ventilation system further comprises an accessory storage device that is adjustable vertically in the fume hood. The ventilation hub can also be detachably securable to a primary ventilation system and a work surface.

In an alternative embodiment the ventilation hub further comprises a self contained air purifying system containing an air filtration and absorption device that is detachably secured atop the ventilation hub, and it is designed to remove air from the ventilation hub and purify and re-introduce air to an exterior environment. This alternative ventilation hub can also comprise lights mounted at an angle of inclination similar to that of the top walls. Another addition can include at least one flat screen electronic display that can have a membrane control pad or mouse. In some embodiments the display can be linked to an interactive system capable of operating software to assist in instruction and completion of tasks.

The self contained air purifying system can include a motorized exhaust air filtration system, one or more light sources can be disposed above the top wall panels and parallel therewith such that the work areas below the fume hood enclosure can be illuminated. The air purifying system can also be configured to comprise electronic display panels for each fume hood enclosure. The electronic displays can be communicatively connected to a computer such that software programs may be viewed on the electronic displays. Communicatively connected involves have a connection that enables the electronic display to operate software that is processed on a computer system. The electronic display can also include interactive hardware such as a keypad, keyboard, mouse, or a similar device to provide a means to interact with a computer that is connected to the electronic display. The connection can be hardwired or wireless. The electronic displays can be disposed at an angle to facilitate comfortable viewing through a top wall panel while an individual is working underneath a fume hood enclosure. Software programs used in association with the electronic displays can include instructional materials capable of being modified by an instructor, adaptable to a particular experiment undertaken, and loaded at a primary instructor station for use by all lab personnel on the electronic displays. Optionally, individual software programs may be loaded into each individual workstation. Software can be programmed to comprise an active guide for experimentation and may help to identify experimental milestones or problem areas that may be encountered, help identify causes and cures of problems to help students remain on track and can help students work safely. Additionally, the electronic displays can be programmed to display a “timed” sequence of events. The timed sequence of events enable a student to log information at key points during an experimental process, and at the end, the software can download and track, at timed points, where notes were taken and correlate the experimental process in pictured screens to the notes.

The self contained air purifying system can be powered by means of utility lines that pass through a utility conduit contained within the ventilation hub. The air purifying system can comprise specialized filtration and chemical absorption assemblies for filtering specific targets. Additional features of the air purifying system can include individual switches to control each of the light sources (off/low/high) at each individual workstation. Other features can include a switch for operating the air purifying filtration system at point of use in either a low exhaust mode when mildly hazardous compounds are being used, or at high exhaust volume mode when active experimentation is undertaken. It is also possible to operate all air purifying system systems within the lab from an instructor control panel in the laboratory with similar low/high/off capability. A digital membrane control pad may also be provided in the ventilation hub to operate the purifying system, toggle light sources, or control the computer and/or electronic display.

It is a general object of the present invention to provide an modular desktop-type ventilation system that is adjustable and adaptable to various situations.

It is another object of the present invention to provide a desktop-type ventilation system having improved airflow.

It is another object of the present invention to provide a desktop-type ventilation system wherein a fume hood enclosure may be readily broken down and stored.

It is another object of the present invention to provide a desktop-type ventilation system wherein the fume hood enclosure may be adjusted in increments of height as preferred by a user.

It is another aspect of the present invention to provide a desktop-type ventilation system comprising a ventilation hub with an adjustable shelf and accessory system.

It is another object of the present invention to provide a desktop-type ventilation system wherein a ventilation hub includes mechanical, electrical and data service fixtures and/or utility lines.

It is yet another object of the present invention to provide a desktop-type ventilation system with a self-contained air purifying system.

It is a further object of the present invention to provide a desktop-type ventilation system with an interactive display system.

These and other aspects, features, and advantages of the present invention will become readily apparent to those having ordinary skill in the art upon reading the following detailed description of the invention in view of the several drawings of the invention.

### BRIEF DESCRIPTION OF THE DRAWINGS

The nature and mode of operation of the present invention will now be more fully described in the following detailed description of the invention in view of the accompanying drawing figures, in which:

FIG. 1 is a perspective view of a desktop-type ventilation system according to the present invention in the downward discharge version;

FIG. 2 is an exploded view of the primary hood related components of a desktop-type ventilation system according to the present invention;

FIG. 3 is an exploded view of a fume hood and a ventilation hub according to the present invention;

FIG. 4 is an exploded view of a ventilation hub according to the present invention;

FIG. 5 is an exploded view of an upper ventilation coupling according to the present invention;

FIG. 6 is a plan view of a ventilation hub according to the present invention;

FIG. 7 is a plan view of a ventilation hub anchor plate according to the present invention;

FIG. 8 is a plan view of a ventilation hub bottom anchor plate according to the present invention;

FIG. 9 is a top plan view of a desktop-type ventilation system with downward exhaust according to the present invention;

FIG. 10 is an elevation view of a desktop-type ventilation system according to the present invention;

FIG. 11 is a sectional view of a desktop-type ventilation system according to the present invention taken generally along line 11-11 of FIG. 9, which illustrates the present invention connected to a primary ventilation system beneath the worktop;

FIG. 12 is a sectional view of a desktop-type ventilation system according to the present invention taken generally along line 12-12 of FIG. 9;

FIG. 13 is a sectional view of a desktop-type ventilation system according to the present invention taken generally along line 13-13 of FIG. 10;

FIG. 14 is a partially exploded view of a side wall extension panel for directing air towards the ventilation hub, and separating each adjacent work area from one another;

FIG. 15 is an enlarged perspective view of an adjustable channel for attachment to rear edge of side wall panel according to the present invention;

FIG. 16 is an enlarged perspective view of a spacer wall for attachment to the bottom edge of the side wall panel according to the present invention;

FIG. 17 is a perspective view of a plurality of fume hoods according to the present invention, with side wall panel extensions, work trays, and adjustable shelves according to the present invention;

FIG. 18 is a perspective view of the housing wall panel components of a bench top hood system with fume hoods according to the present invention;

FIG. 19 is a perspective view of bench top work trays according to the present invention;

FIG. 20 is a front elevation view of a plurality of desktop-type ventilation systems according to the present invention connected to a primary ventilation system below a worksurface;

FIG. 21 is a plan view of a plurality of desktop type ventilation systems connected to a primary ventilation system below a worksurface;

FIG. 22 is an exploded view of the ventilation hub and anchor plate above and below a worksurface of a desktop-type fume hood system according to the present invention;

FIG. 23 is an exploded view of a modular duct system for coupling a primary ventilation system to a desktop-type ventilation system of the present invention.

FIG. 24 is a front elevation view of two desktop-type ventilation systems according to the present invention with modular fit together ventilation exhaust components mounted atop the ventilation hub and connected to a primary ventilation system overhead;

FIG. 25 is a front elevation of a desktop-type ventilation system with air purifying system installed atop the ventilation hub according to the present invention; and, FIG. 26 is a top plan view of an air purifying system of a desktop-type ventilation system according to the present invention.

### DETAILED DESCRIPTION OF THE INVENTION

At the outset, it should be appreciated that while the present invention is described with respect to what is presently considered to be the preferred embodiments, the invention is not limited to the embodiments specifically recited herein. In the detailed description that follows, like drawing numbers on different drawing views are intended to identify identical structural elements of the invention. The terms/phrases “desktop” and “desktop-type” as they relate to ventilation systems are intended to refer to ventilation systems, fume hoods, etc., that are compact, portable, and primarily configured for placement on desktops, benchtops, and similar work surfaces, etc. The present invention may include several features described in U.S. patent application Ser. No. 11/013,169, which application is incorporated herein by reference in its entirety.

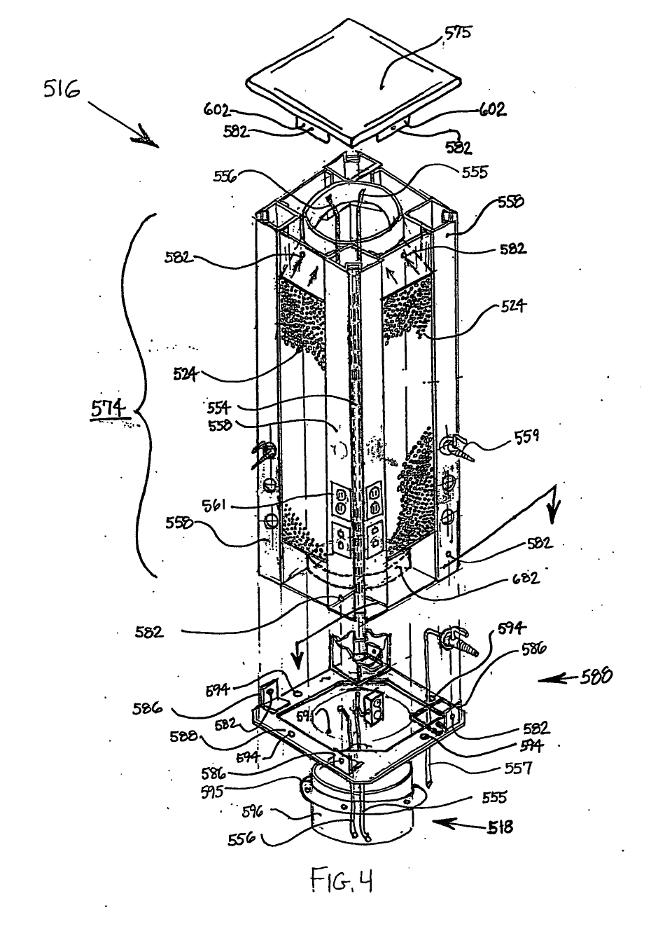

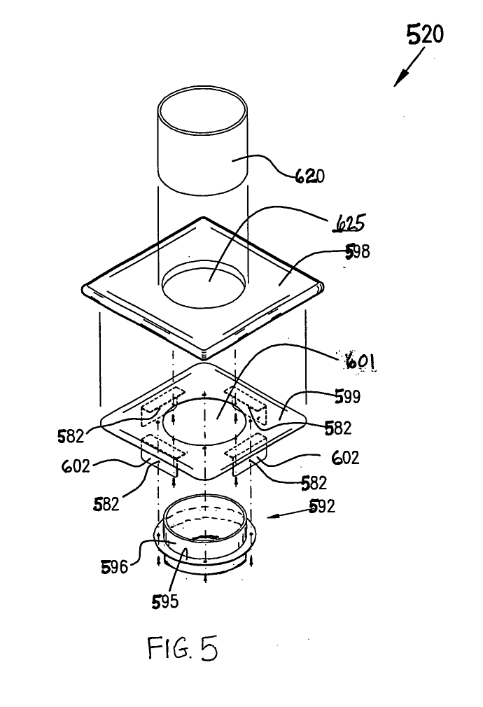

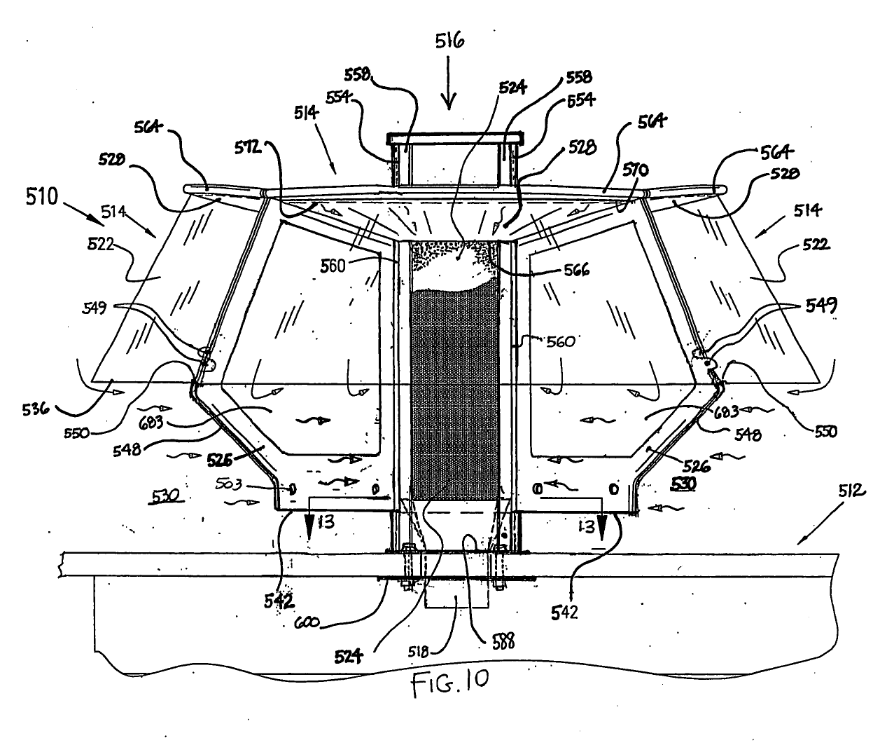

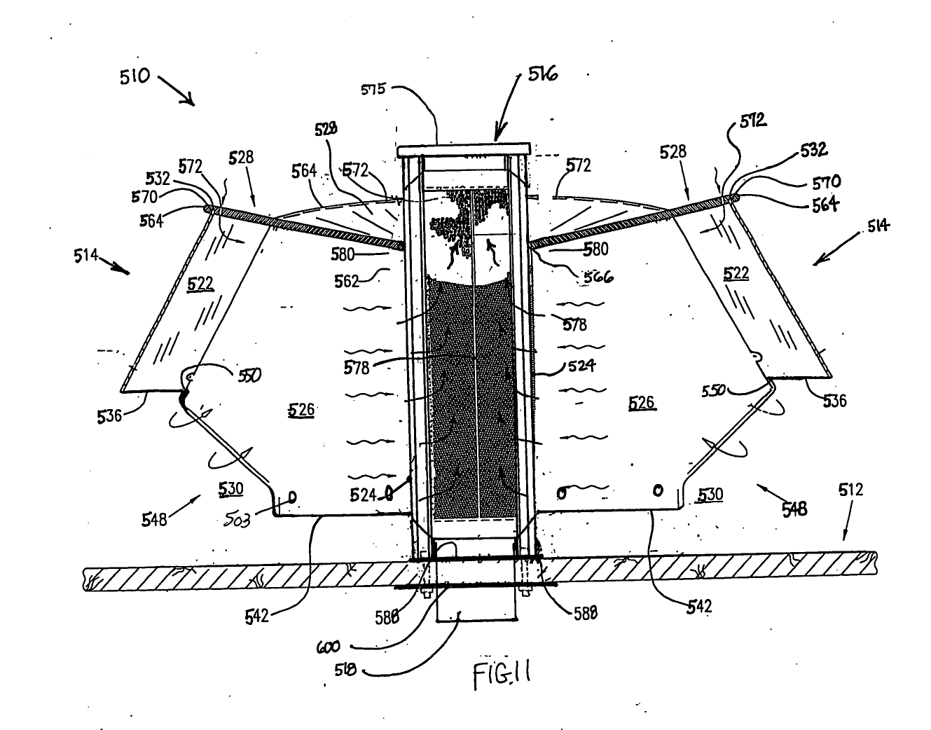

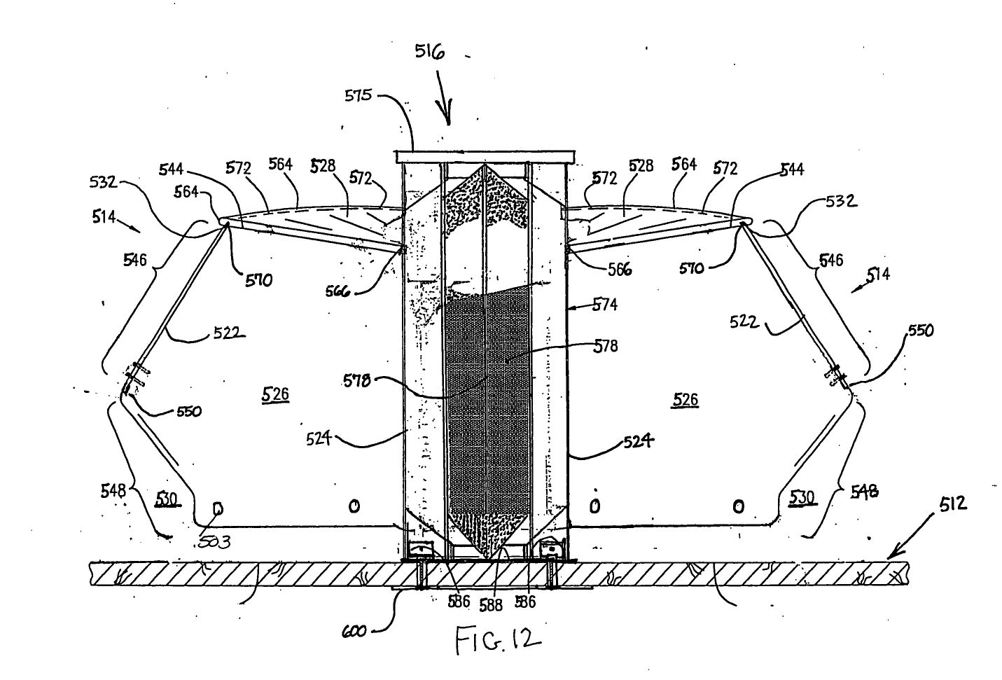

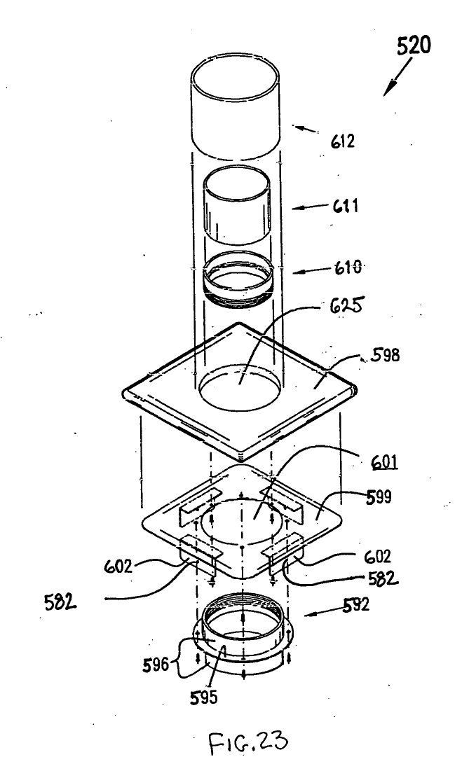

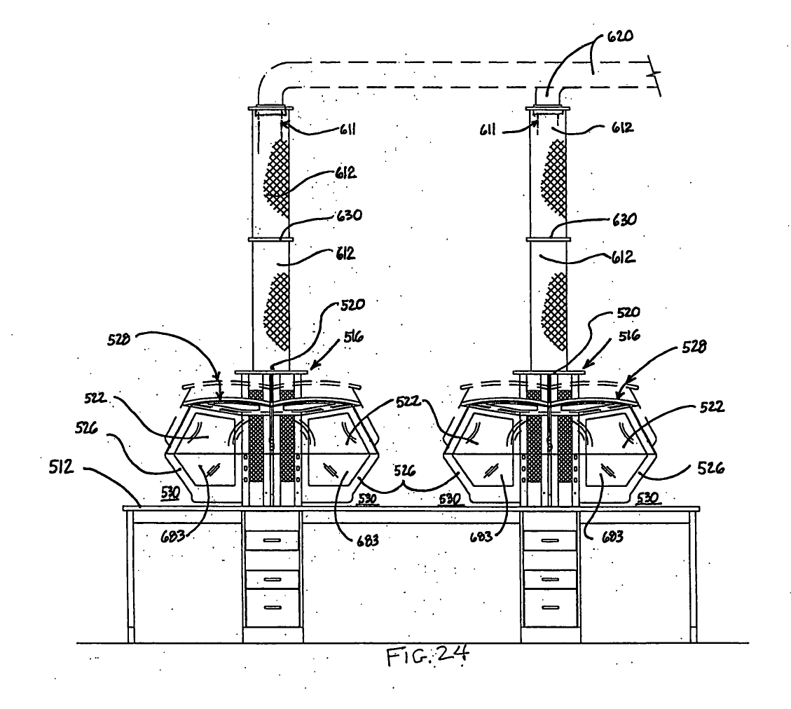

Referring now to the figures, FIGS. 1-3, 10-12, 17, 20, 24 and 25 illustrate desktop-type ventilation system 510 according to the present invention placed on work surface 512. Desktop-type ventilation system 510 broadly comprises at least one fume hood enclosure 514 and ventilation hub 516. Ventilation hub 516 is provided to connect one or more fume hood enclosures 514 to primary ventilation system 620 (see FIGS. 21 and 24), e.g., a primary ventilation system of a building or other air filtering system, such that an area of low pressure may be created under the fume hood. The area of low pressure tends to draw air into fume hood enclosure 514 and evacuates the air in the direction of the arrows (see FIGS. 10 and 11). In one embodiment, ventilation hub 516 is detachably securable to work surface 512 (particularly wherein utility lines are not installed and wherein the system is vented downward). Preferably, ventilation hub 516 is centrally disposed upon work surface 512, e.g. a desktop, and is connected to primary ventilation system 620 by means of lower ventilation coupling 518 (shown in FIG. 4, 10, 11, and 20) as it passes through aperture 590 (see FIG. 22). Alternatively, as illustrated in FIGS. 5, 23 and 24, ventilation hub 516 may be secured to primary ventilation system 620 by means of upper ventilation coupling 520.

Referring specifically now to FIGS. 1-3, and 9-12, each fume hood enclosure 514 generally comprises front wall panel 522, rear wall 524, which is a wall of the ventilation hub, side wall panels 526, and top wall panel 528. In one embodiment, rear wall 524, side wall panels 526 and top wall panel 528 can be planar, flat, and can have lights, whereas front wall panel 522 is arcuate and curved. Front wall panel 522, rear wall 524, side wall panel 526 and top wall panel 528 are detachably securable to each other and to ventilation hub 516, such that the desktop-type ventilation system 510 may be readily disassembled. In an embodiment, front wall panel 522 is detachably securable to side wall panels 526 and top wall panel 528. Front wall panel 522 serves as a viewing shield to allow individuals to view their work under the hood while simultaneously preventing/minimizing injury that may occur. With the exception of front wall panel 522, which is fully optically clear in one embodiment, top wall panel 528 and side wall panels 526 of the fume hood enclosure preferably contain viewing panels 683, which can be made from optically clear material, secured within a frame formed or constructed from heat, shock, and chemically resistant materials. To accomplish this the fume hood side wall 526 and top panels 528 can be framed allowing a light transmitting material to be inserted. In a one embodiment, opaque portions of walls can be formed from a cellulose fiber reinforced phenolic resin core material, such as Trespa Athlon™, currently available from Trespa North America of California. It should be appreciated, however, that the specific materials from which the walls of the fume hood may be formed may vary according to the intended use of the desktop-type ventilation system, for example, metals, plastic, glass, fiberglass, resins, wood, or combinations thereof, etc., can be used.

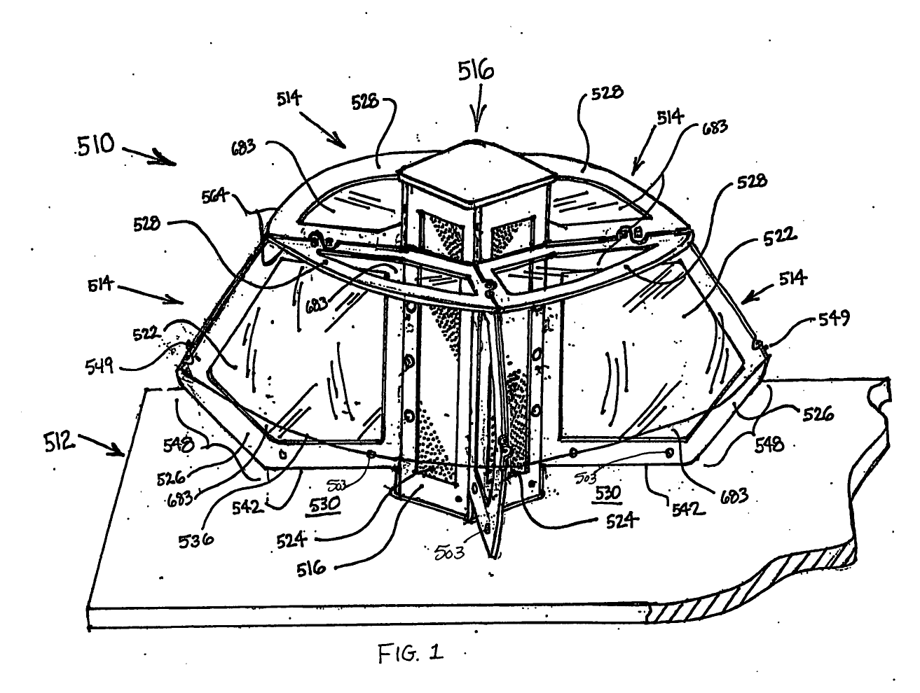

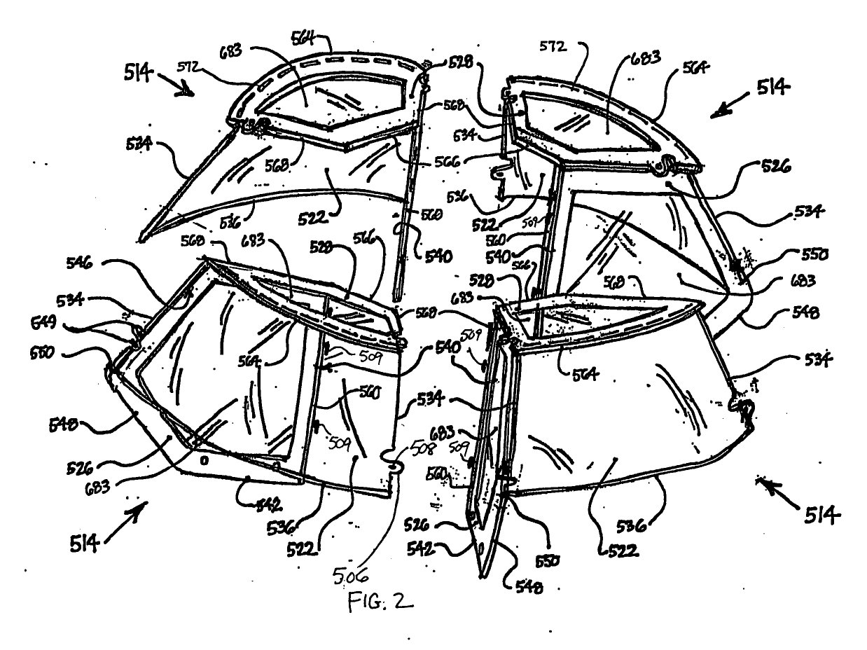

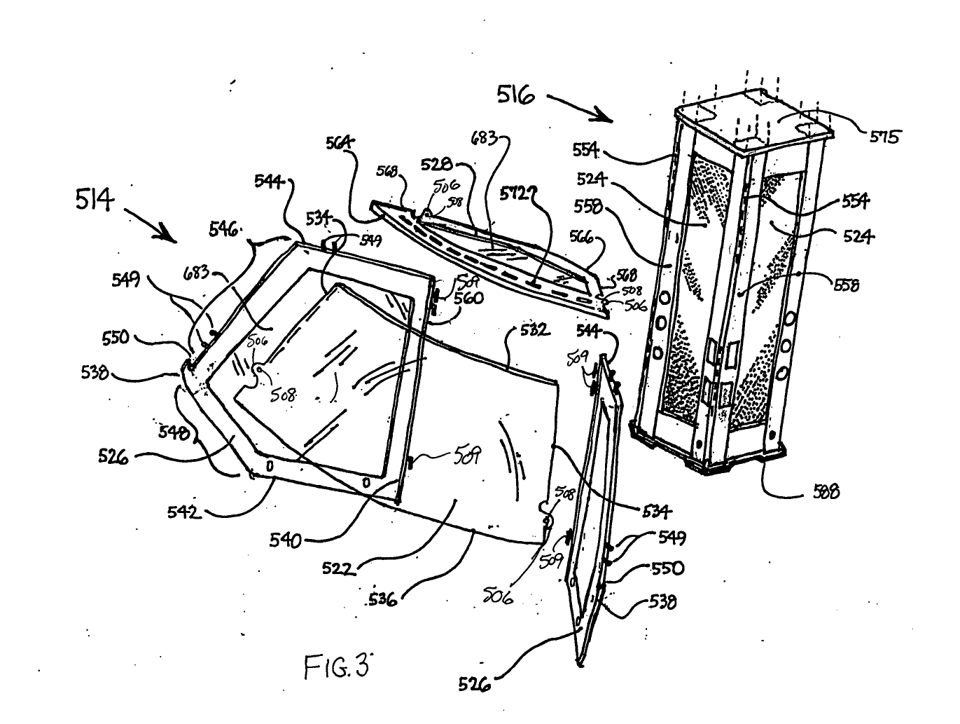

Front wall panel 522 (viewing shield) is provided to prevent/minimize injury to individuals working under the fume hood and defines workstation opening 530. As seen in FIG. 2, front wall panel 522 comprises front wall upper edge 532, front wall side edges 534, and front wall lower edge 536. Front wall upper edge 532 and front wall lower edge 536 are arcuate and front wall upper edge 532 has a radius that is smaller than that of front wall lower edge. Front wall upper edge 532 is configured for receivable fit within arcuate groove 570 (see FIG. 12) of top wall panel 528. Front wall side edges 534 are configured for receivable fit on the bottom lip 550 of the front edge of hood side wall panel 526 and the side wall edges 534 may also have protrusion 506 over the center line of hood side wall panel 526 such that a centering hole within front wall panel 522 is possible. Protrusion 506 mates with a corresponding protrusion 506 of adjacent front wall side edge 534. In the embodiment illustrated, protrusion 506 comprises an “s” edge and includes pinhole 508 for receiving a pin to assure that front wall panel 522 is correctly placed. A pin or hand operated fastener may be used to detachably secure front wall panel 522 to the front edge of side wall panel 526 (see FIG. 3). In one embodiment, front wall panel (viewing shield) 522 extends from the top of the fume hood to a position that is generally intermediate the vertical height of the fume hood. In another embodiment, front wall panel (viewing shield) 522 is wholly transparent and formed from heat, shock, and chemically resistant materials, and more preferably, is formed from a lightweight, transparent acrylic or polycarbonate; it should be appreciated, however, that the specific materials from which front wall panel 522 may be formed may vary with the intended use of the desktop-type ventilation system 510. Front wall panel (viewing shield) 522 can be molded to maintain an arcuate and outwardly sloping configuration. The arcuate and sloped nature of the front wall panel (viewing shield), which slopes outward from front wall upper edge 532 to front wall lower edge 536, tends to increase the work area under the fume hood and improves air flow, field of view/line of sight by reducing glare from various angles, and promotes the efficient and safe use of the fume hood (ergonomics). The arcuate and sloped nature of the front wall (viewing shield) 522 also acts to increase the amount of light that is able to reach the work surface. While front wall (viewing shield) 522 is illustrated as being devoid of a sash member for substantially closing the front wall when not in use, the front wall may be configured to comprise such a feature.

Side wall panels 526 can be configured to comprise metal track 560 comprising means for adjustably securing the sidewalls to the ventilation hub. Metal track 560 is disposed along the rear vertical edge of hood side wall panel 526 and comprises adjustable securing means including but not limited to indexed fasteners 509 which allow the hood side wall panel 526 to be adjustably secured within indexed recess track 554 of square channel edge 558 of the ventilation hub 516. Side wall panels 526 diverge with respect to one another from rear wall 524 to front wall (viewing shield) 522. The divergent configuration of side wall panels 526 acts to funnel air drawn into the fume hood toward ventilation hub 516 such that air is more efficiently and effectively evacuated from below the fume hood enclosure. Side wall panels 526 comprise side wall front edge 538, side wall rear edge 540, side wall bottom edge 542 and side wall top edge 544. Side wall front edge 538 comprises sloped portion 546, anchor post devices 549 and notch portion 550. The angle of sloped portion 546 generally correlates with the slope of front wall (viewing shield) 522. Side wall front edge 546 contains two identical fasteners 549 which are securely anchored into side wall front edge 546 and are utilized to align and secure the front wall (viewing shield) 522. Cutaway portion 548 generally corresponds with workstation opening 530 and is generally provided to reduce the footprint of the fume hood and increase the area of the work space. Cutaway portion 548 also tends to promote more efficient and safe use of the fume hood (ergonomics), provide reductions in the weight of the fume hood side wall panel, and tends to increase the field of view/lines of sight to the work area such that individuals, e.g., instructors, may more effectively monitor the work area. Proximate the interface of sloped portion 546 and cutaway portion 548 is notch portion 550. Notch portion 550 is provided for receiving front wall panel 522 and providing a flush front appearance. Attaching front wall panel 522 using notch 550 on side wall panel 526 can be accomplished in various other way that include using screws that are threaded through front wall panel 522, using and adhesive to secure front wall panel 522 to side wall panel 526, or other similar attachment means are considered within the spirit and scope of the invention. Also inserting front wall panel 522 into a groove on side wall panel 526 is another possible attachment method. Front wall panel 522 may be secured to the side wall posts 549 by means of appropriate fasteners such as the anchor posts 549, screws, threaded bolts, pushpins, or may be held in place by a tension force, e.g., by oppositely directed forces of adjacent front wall panels. Side wall rear edge 540 can be routed and beveled to accept the detachable rear adjustment track 560 which can facilitate side wall panel 526 to be hung and secured on ventilation hub 516. Various fasteners may be utilized to attach rear adjustment track 560 to side wall rear edge 540. Side wall bottom edge 542 is generally provided to receive a vertical adjustable spacer wall 651 (see FIG. 16). The vertical adjustable spacer wall 651 is available in at least one height and may include many heights to accommodate the height adjustment ranges of the side wall panel 526 for contacting desktop 512 and may include rubber feet for preventing movement of the bottom surface thereon or may include adjustment and anchorage holes to affix spacer wall 651 to work tray 500 (FIG. 17 and 19) and to side wall panel 526. Spacer wall 651 enables side wall panel 526 to be adjust vertically to accommodate various experiments or users. The number of adjustment holes 503 can be increased incrementally and can be varied. Adjustment holes 503 in spacer wall 651 and side wall panel 526 are intended to be aligned and pushpin or another similar securing means is used to hold the adjusted wall in the desired position. Modular work trays 500 (see FIG. 17 and 19) surround the perimeter of the ventilation hub and the front circumference of the work tray can in some aspects match the bottom edge radius of the front panel 522. Work tray 500 is attached to ventilation hub 516 and to spacer wall 651 at attachment track 504 using a fastening means that can include, but is not limited to: threaded bolts, push pins, and screws. Side wall top edge 544 is generally provided for supporting top wall panel 528. Side wall top edge 544 can be arranged to slope upward from the rear of the fume hood to the front of the fume hood (see FIGS. 10, 11 and 12) and comprises two posts 549 anchored within the side wall for securing top wall panel 528. Various other securing means can be substituted for posts 549 and it should be appreciated that posts 549 comprise only one of many viable securing means known to one of ordinary skill in the art.

Ventilation hub 516, in the embodiment illustrated is shown as being rectangular in shape. Rear wall vent outlet orifice 524 corresponds to the rectangular shape of ventilation hub 516. Ventilation hub 516 may be shaped other than rectangular, such as oval, circular, triangular, etc.

Top wall panel 528 comprises top wall front edge 564, top wall rear edge 566 and top wall side edges 568. Top wall side edges 568 can be configured to include an “s” shape protrusion 506. Protrusion 506 having the “s” shaped pattern can comprise. pinhole 508 for positioning the top panel correctly over the hood side wall panels 526. Top wall front edge 564 is shown to be arcuate and includes arcuate groove 570 on its interior surface. Arcuate groove 570 (see FIG. 11) can be provided to accept front wall upper edge 532 of front wall (viewing window) 522 therein. Proximate and along the front edge are a series of orifices 572 for drawing air into the fume hood. Orifices 572 tend to draw air into the fume hood from above such that any air collecting under the fume hood near top wall panel 528 is evacuated. Top wall rear edge 566 generally corresponds with the width and shape of ventilation hub 516. Top wall side edges 568 diverge with respect to one another from top wall rear edge 566 to top wall front edge 564 and generally correspond with diverging side wall panels 526. Top wall panel 528 is configured to be secured to top edges 544 of side wall panels 526. Thus, top wall panel 528 is configured for directing and causing air to be funneled toward ventilation hub 516 and more specifically into rear wall vent outlet orifice 524. It should be appreciated that rear wall vent outlet orifice 524 may be divided into a plurality of orifices. While in one embodiment the top wall is opaque, it may be configured to comprise a viewing window therein, or may comprise a wholly transparent material for allowing light to pass for illuminating the work area.

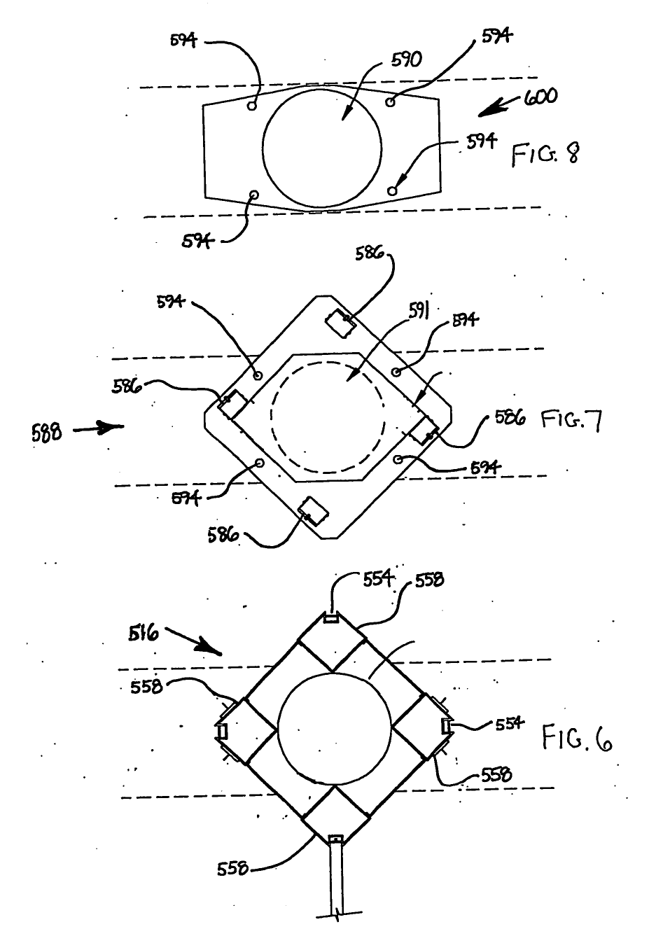

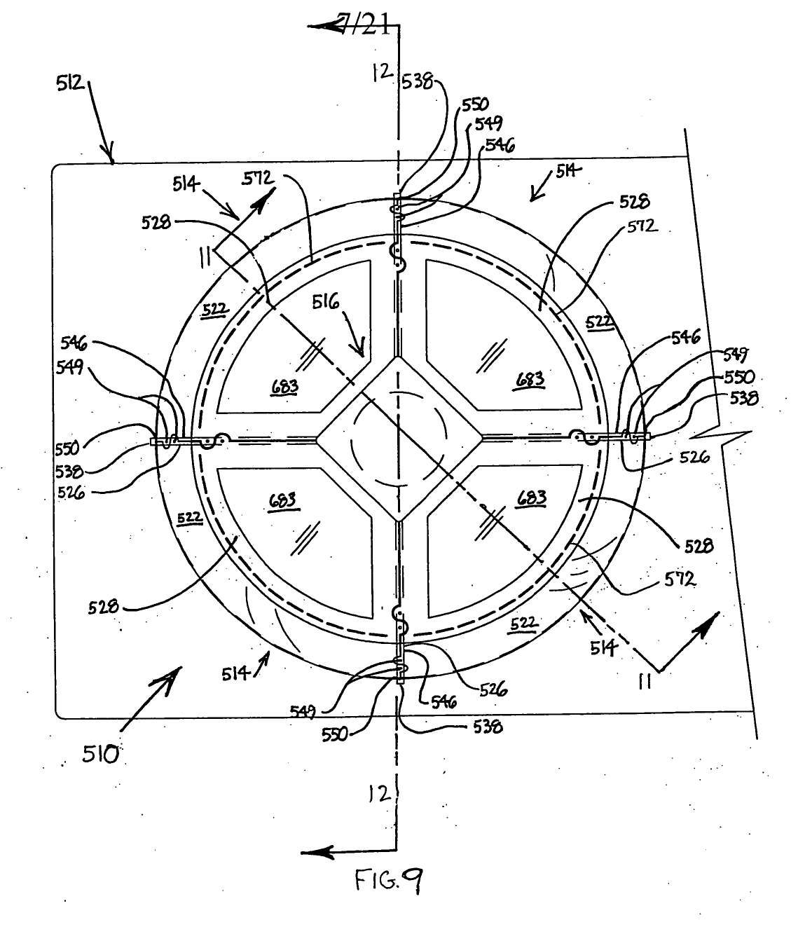

Referring more specifically now to FIGS. 1, 3, 4-8, 10, 11, 22 and 23, ventilation hub 516 is provided for connecting the fume hoods to a primary ventilation system 620, such that air may be evacuated from the fume hood(s) 514. Generally air enters the fume hood area at workstation opening 530. Air may also enter through orifices 572. Ventilation hub 516 broadly comprises ventilation core 574 (see FIG. 4), which is configured for securing lower ventilation coupling 518, upper ventilation coupling 520 and/or ventilation cover 575. In one embodiment, ventilation core 574 is formed of stainless steel or other appropriate material and comprises at least one vent 524, which can comprise a screened material formed from stainless steel, and more specifically, 50-60% open mesh, but the percentage of open mesh can vary. Other materials used to construct ventilation core 574 can include, but is not limited to other metals, plastic, glass, fiberglass, resins, wood, or combinations thereof, etc.

Ventilation hub 516 can also comprise rectangular channels 558 and in one embodiment four channels 558 are used and are substantially mated to ventilation hub base anchor plate 588. Each channel can provide anchorage to the hub base anchor plate 588 and also provides for hood wall adjustability with one or more recessed tracks 554. This arrangement can also provide a passageway for electric power lines 555, data communication lines 556, and/or mechanical service lines 557. Electrical outlets 561 and fixtures for these various lines, such as mechanical service fixture 559 can be installed on the exterior of ventilation hub 516. Where ventilation core 574 comprises a plurality of vents 524 and fewer fume hoods are secured to the to the ventilation hub 516, vents 524 may be closed utilizing an appropriately fitting cover, if desired. In a one embodiment, the area of vents 524 is large such that static pressure drops are lowered. As a result, the fume hoods may be safely operated using low velocity fans and blowers, which can draw air into the hood at velocities as low as 35 cubic feet per minute/hood. The ability of the ventilation system of the present invention to utilize low velocity fans lowers fume hood face velocities, noise levels and reduces the volume of air that is drawn into the fume hoods, which can result in significant cost savings with regard to heating/air conditioning.

Ventilation core 574 is adapted to receive channeling insert 578 therein, which acts to more efficiently and effectively draw air from within fume hood enclosure 514. In the embodiment illustrated, channeling insert 578 (see FIG. 11) comprises a stainless steel screen that has a cross-sectional shape forming a cross. The cross structure forms individual air passages, one for each vent 524, within the ventilation core 574. Channeling insert 578 is designed to reduce turbulence within the ventilation core 574. It should be appreciated that while channeling insert 578 is illustrated as having a cross-sectional shape in the form of a cross, the cross-sectional shape of the channeling insert will depend upon the number of vents 524 disposed in ventilation core 574. A further benefit provided by channeling insert 578 is that it tends to prevent individuals from viewing, through vents 524, work areas under other fume hoods that may be secured to ventilation hub 516. It should be appreciated that while ventilation core 574 is illustrated as comprising a rectangular parallelepiped, the ventilation core may be shaped otherwise, e.g., cylindrical, polygonal, etc., and its related components, e.g., upper and lower ventilation couplings, side and front wall panels, etc., may be correspondingly configured for mating fit therewith. In a cylindrical embodiment, channeling insert 578 may comprise a cross-sectional shape in the form of a cross, or may comprise an Archimedes screw-type device configured for rotation within ventilation core 574 under the force of air being forced therethrough, e.g., as by primary ventilation system 620.

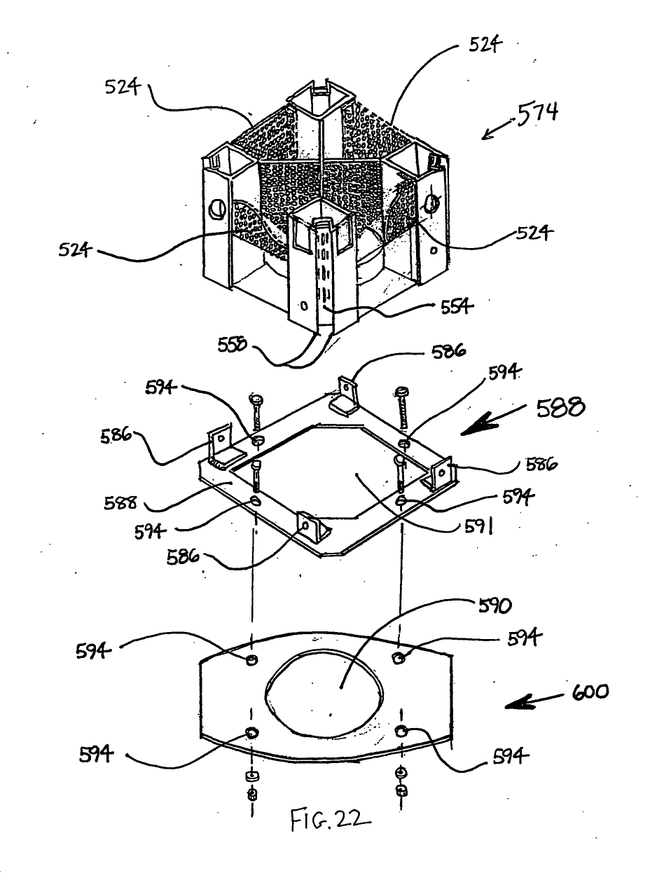

In one embodiment, the desktop-type ventilation system 510 of the present invention may be detachably mounted to primary ventilation system 620 with lower ventilation coupling 518 that passes through a desktop or work surface (See FIGS. 20-23). In such instance, the desktop-type ventilation system 510 may be secured to the primary ventilation system 620 by means of lower ventilation coupling 518, which in this case comprises aperture 590 and anchor plates 588 and 600. In such configuration, the upper end of ventilation core 574 may be closed off by ventilation cover 575. As illustrated in FIGS. 4 and 19, lower ventilation coupling 518 will slip through aperture 590 of ventilation hub base anchor plate 588 and opening in upper surface mounting plate 600. Coupling 518 will affix to ventilation collar 682 (see FIG. 4) of the of ventilation core 574 through fixed desktop or work surface 512. Lower ventilation anchor plate 588 corresponds to the cross-sectional shape of ventilation core 574 shown in FIG. 4, 6, 13 and 22 and generally comprises formed angles 586 attached to base plate 588. Base plate 588 comprises aperture 591 configured to allow passage of electrical, data lines and mechanical services and for accepting passage of duct coupling 518 therein. Base plate 588 further comprises a plurality of throughbores 594 for securing the lower ventilation anchor plate coupling to a desktop or work surface 512. Duct coupling 518 generally comprises annular ring portion 595 and duct receiving portion 596, which is configured for connection to a duct of a primary ventilation system 620 or other filtering system and to the lower ventilation collar 682 of ventilation core 574. Annular ring portion 595 may be detachably secured to bottom face of worktop 512 by appropriate fastening means. The top portion of 596 of coupling 518 shown on FIG. 4 is configured to slip over the exterior of the lower ventilation collar 682 of ventilation core 574. In one embodiment, each of the formed angles 586 includes appropriate means for detachably securing ventilation core 574 thereto, for example, throughbores 582 for receiving threaded fasteners, or threaded throughbores can be used to accept threaded fasteners.

Alternatively, where ventilation of the fume hood enclosures is to be provided by, for example, an overhead primary ventilation system 620 (FIG. 24), upper ventilation coupling 520 (FIG. 5 and 23) may be utilized. As shown in FIGS. 5, 23 and 24 upper ventilation coupling 520 generally comprises upper plate 598, lower plate 599 and duct coupling 592. Upper plate 598 and lower plate 599 comprise apertures 625 and 601 for passing duct receiving portion 596 of duct coupling 592 therethrough. Annular ring portion 595 of duct coupling 592 may be detachably secured to upper plate 598 and lower plate 599 by appropriate fastening means. Upper plate 598 can be made from Trespa Athlon TM. Lower plate 599 can be formed from stainless steel and further comprises angle members 602 having throughbores 582 for securing the upper coupling 520 to the ventilation core 574. Upper ventilation coupling 520 may also be configured to comprise one or more electrical outlets and/or illumination devices (not shown) for illuminating the work area under each fume hood enclosure 514. For example, upper ventilation coupling 520 may comprise four electrical outlets and/or four illumination devices where the desktop-type ventilation system 510 comprises four fume hoods and the top walls 528 of each fume hood comprise a viewing window. As illustrated in FIGS. 23 and 24, upper coupling 520 may also be configured for accepting duct coupling 592 comprising threaded duct receiving portion 596, for accepting threaded coupling 610. Threaded coupling 610 is adapted for mating fit with one or more modular ducts 611 (FIG. 24), which connect the desktop-type ventilation system 510 with the primary ventilation system 620. Sleeve 612, which may comprise an aesthetically pleasing material such as stainless steel mesh, is provided for covering modular ducts 611. Multiple length sleeves 612 and multiple length modular ducts 611 are attached with at least one phenolic disk mating coupling 630.

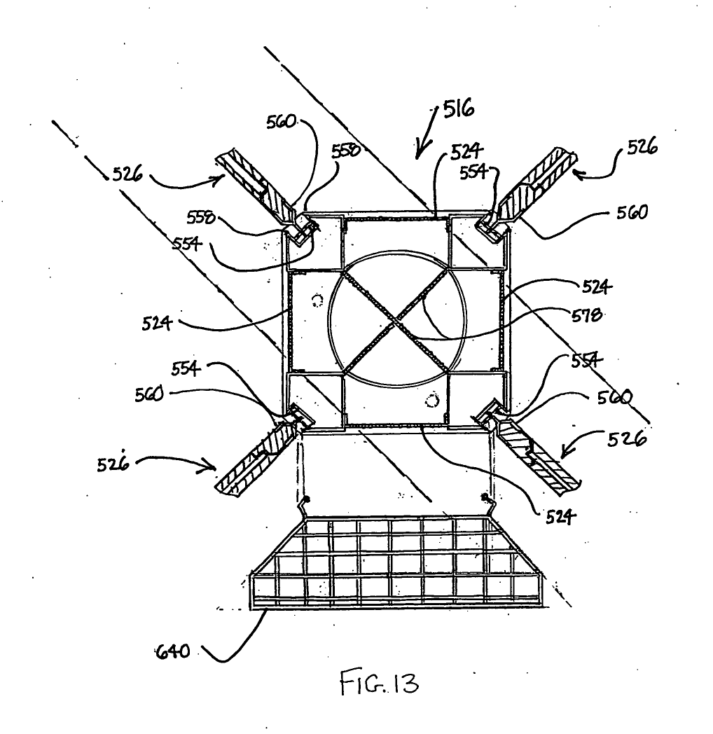

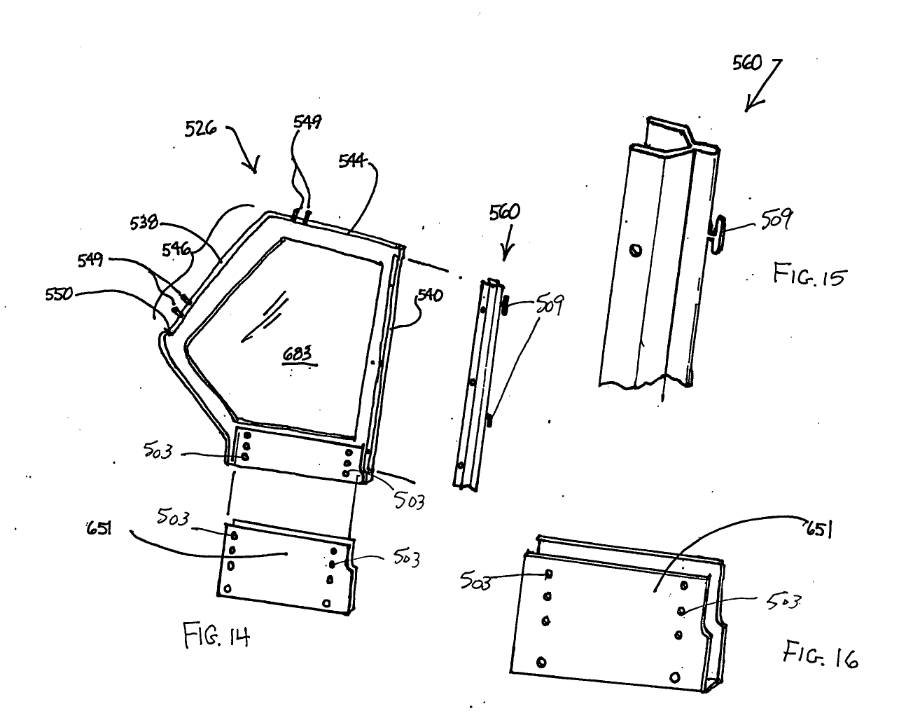

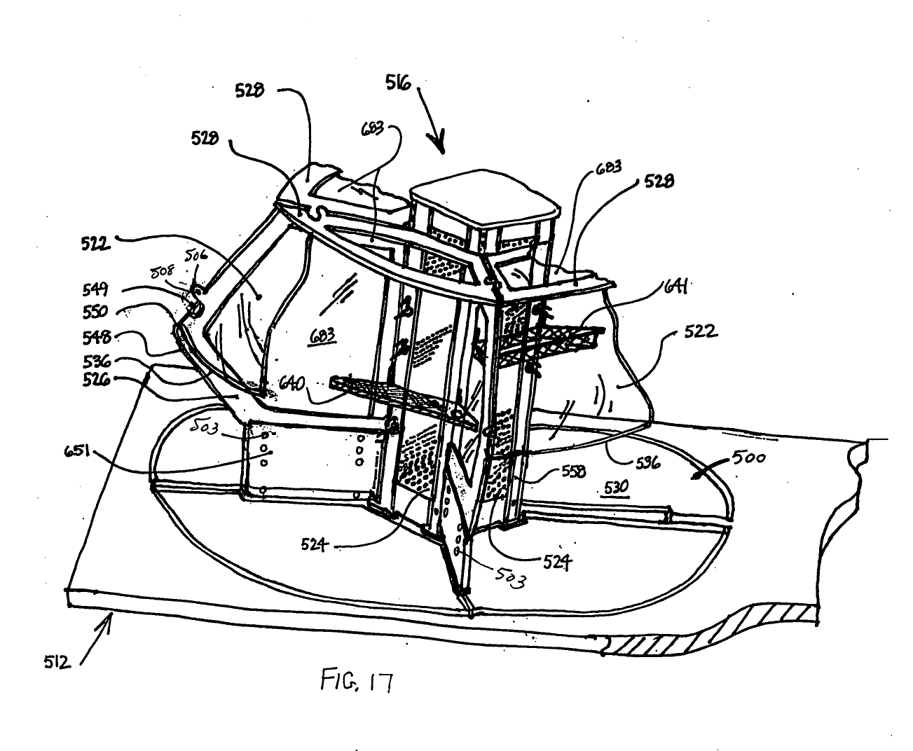

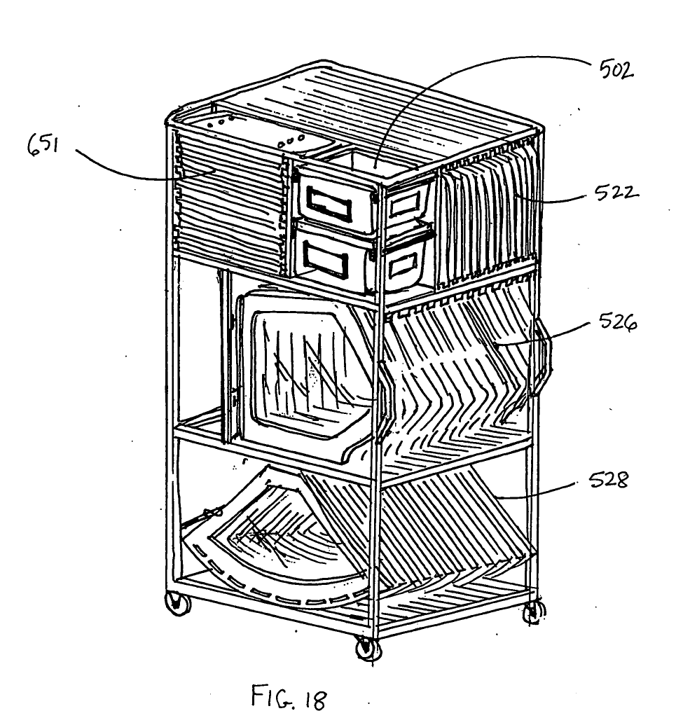

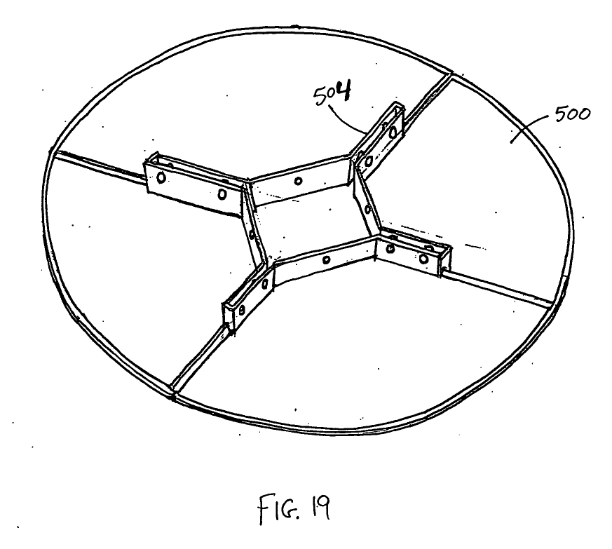

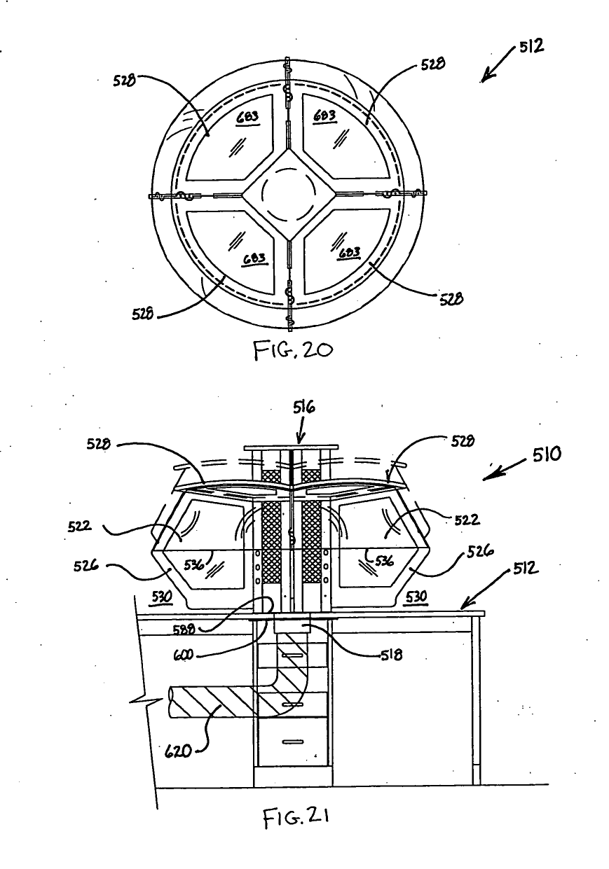

The present invention is generally configured to be easily set up and broken down after use. After side walls 526, top walls 528, and front walls 522 have been appropriately secured to one another by means of fasteners, which are made up of protrusion 506 and pinhole 508 cooperating with anchor post 549 onto ventilation hub 516, a user need merely disengage protrusion 506 from anchor post 549 (which can be can be designed to be removed without any tools), and remove twelve panels to a cart specifically designed for storage of hood system panel components (FIG. 18). Other fastener alternatives can include screws, rivets, pins, etc. Thereafter, the ventilation hub 516 provides general ventilation, if desired, and also serves to house all data, electrical, and plumbing services and service fixtures within channels 558 and also provides slotted recessed vertical tracks for hanging shelves 640 or hanging baskets 641 (see FIGS. 4, 13 and 17). Slotted tracks 554 provide a structure that allows the accessories to be height adjustable. Where a plurality of fume hoods are secured to the ventilation hub 516, the desktop-type ventilation system 510 comprises a pod, or cluster, of fume hoods utilizing a common connection to primary ventilation system 620 (See FIG. 4, 20, and 24). Disassembly of the desktop-type ventilation system 510 is generally the opposite of assembly. Generally, the first step is to remove front wall fasteners 551 such that front walls 522 may be removed. As illustrated in FIG. 4, 13, and 17, after removal of the front walls, side walls, and top walls, the hanging baskets 641 and shelves 640 can be left in place or adjusted vertically within the slotted track system of the rectangular channels 558. After disassembly and when the desktop-type ventilation system 510 is not in use, the ventilation hub structure 516 remains in place to provide convenient service fixture locations and storage devices as well as lighting overhead.

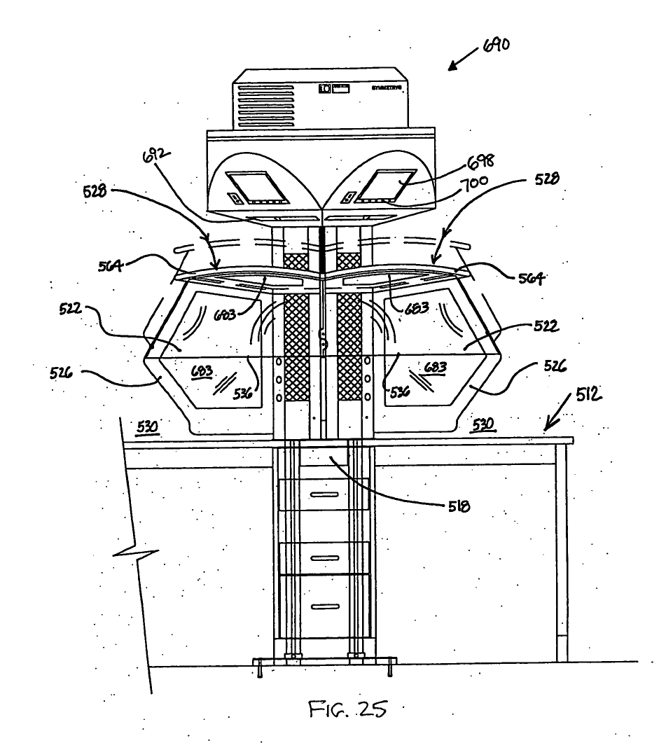

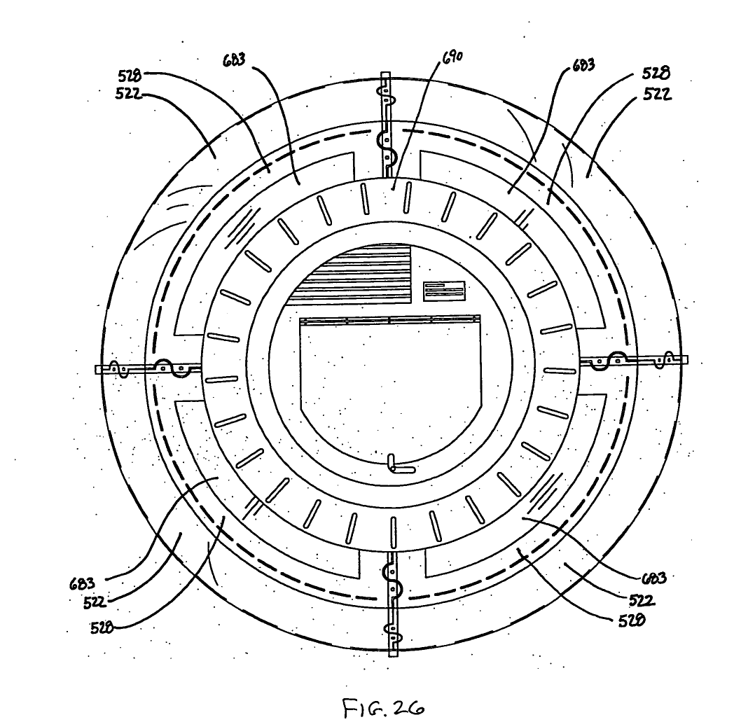

As illustrated in FIG. 25, a desktop-type ventilation system according to the present invention may also be configured to comprise self contained air purifying unit 690. Self contained air purifying unit 690 is generally configured to be secured atop ventilation hub 516. The self contained air purifying system generally allows fume hoods to be added to a laboratory without the need for newly constructing a central ventilation system or modifying a current central ventilation system. Self contained air purifying unit 690 can include a motorized exhaust air filtration system (not shown), one or more light sources 696, one or more electronic displays 698 and controls 700. Individual users can turn on the flat screen display panels 698 in the air purifying system from a membrane control pad located within the nearest set of vertical channels of the ventilation hub. One channel can provide users access to individual touch pads at opposite adjacent sides of the vertical wall panel, and the same user features exist at opposite side of assembly.

Light sources 696 can be disposed above the top wall panels and parallel therewith such that the work areas below the fume hood enclosure can be illuminated. In one embodiment the lights are disposed in the underside panels at the same angle of inclination as the hood top panels over which it cantilevers. Electronic displays 698 are generally provided for more efficiently and effectively providing instruction in an educational type setting. Electronic displays 698 can be communicatively connected to a computer such that software programs may be viewed thereon. Electronic displays 698 can be disposed at an angle to facilitate comfortable viewing through top wall panel 528 while an individual is working underneath a particular fume hood enclosure. Software programs used in association with the electronic display panels can include instructional materials for a particular experiment. Software programs may be modified by an instructor and may be adapted to a particular uniqueness or object of the experiment undertaken. Software programs may be individually loaded into a workstation at control panel 700 or may be communicated to a workstation from a central location by means of a data line passing through the ventilation hub. Each operator of the fume hood in the laboratory can receive information on the lab experiment from an instructor modified or a standard CD of the lab experiment to be undertaken which is loaded into the system from one main console of the lab and which can be utilized by the student from the overhead console ventilation and which the student may interact with the displayed information either at the air purifying system or from within the individual fume hood work area while performing the experiment at the vertical channel nearest the operator. Another alternative is to provide a lab-assist software card unique for the experiment that will be undertaken into the air purifying system and interact with the displayed information either at the air purifying system or from within the individual fume hood work area at the vertical channel within ventilation hub nearest the operator.

Alternatively, each workstation may comprise wireless means for communicating information to be displayed on electronic display panels 698. Software can be programmed to comprise an active guide for experimentation and may help to identify experimental milestones or problem areas that may be encountered, help identify causes and cures of problems to help students remain on track and can help students work safely. Additionally, the electronic displays can be programmed to display a timed sequence of events. The timed sequence of events enable a student to log information at key points during an experimental process, and at the end, the software can down-load and track, at timed points, where notes were taken and correlate the experimental process in pictured screens to the notes.

A self contained air purifying system can be powered by means of utility lines that pass through a utility conduit contained within the ventilation hub. The air purifying system can comprise specialized filtration and chemical absorption assemblies for filtering specific targets. Control panels 700 are provided at each workstation such that the filtration system, light sources 692 (off/low/high) and electronic displays 698 may be controlled. The device may be configured to comprise switches for operating the air purifying filtration system at point of use in either a low exhaust mode when mildly hazardous compounds are being used, or at high exhaust volume mode when active experimentation is undertaken. It is also possible to operate all air purifying system systems within the lab from an instructor control panel in the laboratory with similar low/high/off capability. Digital membrane control pad 702 may also be provided in the ventilation hub to operate the purifying system, toggle light sources, or control the computer and/or electronic display.

Thus, it is seen that the aspects of the present invention are efficiently obtained, although modifications and changes to the invention should be readily apparent to those having ordinary skill in the art, which modifications are intended to be within the spirit and scope of the invention as claimed.

Parts List

| | |
|---|---|
| 500 | Work tray |
| 502 | Fasteners |
| 504 | Side wall panel attachment track |
| 506 | Protrusion |
| 508 | Pinhole |
| 509 | Indexed Fastener |
| 510 | Desktop-type ventilation system |
| 512 | Work surface/desktop |
| 514 | Fume hood enclosure |
| 516 | Ventilation hub |
| 518 | Lower ventilation duct coupling |
| 520 | Upper ventilation coupling |
| 522 | Front wall panel/viewing window |
| 524 | Rear wall-vent outlet orifice |
| 526 | Side wall panel |
| 528 | Top wall panel |
| 530 | Workstation opening |
| 532 | Front wall upper edge |
| 534 | Front wall side edge |
| 536 | Front wall lower edge |
| 538 | Side wall front edge |
| 540 | Side wall rear edge |
| 542 | Side wall bottom edge |
| 544 | Side wall top edge |
| 546 | Sloped portion of side wall front edge |
| 548 | Sloped and vertical cut-away portion of side wall front edge |
| 549 | Shoulder anchor devices on side wall front and top edges |
| 550 | Notch portion/bottom lip on front of hood side wall |
| 554 | Recess track of square channel edge |
| 555 | Electric power lines |
| 556 | Data communication lines |
| 557 | Mechanical service lines |
| 558 | Channel |
| 559 | Mechanical service fixture |
| 560 | Detachable rear adjustment track |
| 561 | Electrical outlet |
| 564 | Top wall front edge |
| 566 | Top wall rear edge |
| 568 | Top wall side edge |
| 570 | Arcuate groove on interior surface of top wall front edge |
| 572 | Orifices (for air) |
| 574 | Ventilation core |
| 575 | Ventilation cover |
| 578 | Channeling insert |
| 582 | Throughbores |
| 586 | Formed angles attached to anchor plate |
| 588 | Base anchor plate for ventilation |
| 590 | Aperture |
| 591 | Opening in base anchor plate |
| 592 | Duct coupling |
| 594 | Throughbores |
| 595 | Annular ring portion |
| 596 | Duct receiving portion |
| 598 | Upper plate |
| 599 | Lower plate |
| 600 | Under surface mounting plate |
| 601 | Aperture within metal plate |
| 602 | Formed angle member |
| 610 | Threaded coupling |
| 611 | Modular ducts |
| 612 | sleeve |
| 620 | Primary ventilation system |
| 625 | Aperture within upper coupling |
| 630 | Phenolic disk mating coupling |
| 640 | Shelf |
| 641 | Basket |
| 651 | Vertical adjustable spacer wall |
| 682 | Ventilation collar |
| 683 | Side and top wall viewing panel |
| 690 | Self contained air purifying unit |
| 692 | Light Source |
| 698 | Electronic Display |
| 700 | Control Panel |
| 702 | Membrane control panel |

What is claimed is:

1. A desktop-type ventilation system comprising:
a ventilation hub comprising at least one vent; and,
at least one fume hood work station, said fume hood work station comprising at least two side walls detachably connected to said hub and at least one top wall detachably connected to said side walls, each of said side walls and said at least one top wall disposed at an angle to funnel air toward said at least one vent.

2. The desktop-type ventilation system of claim 1, further comprising a front wall detachably connected to said side walls defining a work area inlet, wherein a rear wall on the face of said ventilation hub comprises an outlet orifice.

3. The desktop-type ventilation system of claim 2, wherein said front wall is arcuate.

4. The desktop-type ventilation system of claim 3, wherein said front wall has an arcuate surface with a radius on a top edge of said front wall that is smaller than a radius of a lower edge of said front wall such that said front wall slopes outward from said top edge to said lower edge.

5. The desktop-type ventilation system of claim 1, wherein said ventilation hub further comprises at least one adjustable track wherein said side walls and said top wall are adjustably connected to said ventilation hub.

6. The desktop-type ventilation system of claim 1, wherein said ventilation hub further comprises at least one internal channel.

7. The desktop-type ventilation system of claim 6, wherein plumbing, electric, and data lines are inside said channel of said ventilation hub and fixtures for said plumbing, electric and data lines are disposed on the exterior of said ventilation hub.

8. A desktop-type ventilation system of claim 1, further comprising an accessory storage device, wherein said accessory storage device is adjustable vertically in said fume hood.

9. The desktop-type ventilation system of claim 1, wherein said ventilation hub is detachably secured to a primary ventilation system and a work surface.

10. The desktop-type ventilation system of claim 1, further comprising a work tray detachably connected to said ventilation hub.

11. The desktop-type ventilation system of claim 1, further comprising an adjustable spacer wall detachably connected to said side wall.

12. A desktop-type ventilation system comprising:
a ventilation hub comprising at least one vent;
at least one fume hood work station, said fume hood work station comprising at least two side walls detachably connected to said hub and at least one top wall detachably connected to said side walls, each of said side walls and said at least one top wall disposed at an angle to funnel air toward said at least one vent; and,
one air purifying system containing an air filtration and absorption device detachably secured atop the ventilation hub to remove air from the ventilation hub and purify and re-introduce air to an exterior environment.

13. The desktop-type ventilation system of claim 12, wherein said air purifying system further comprises lights mounted at an angle of inclination similar to that of the top walls.

14. The desktop-type ventilation system of claim 12, wherein the air purifying system further comprises at least one flat screen electronic display.

15. The desktop-type ventilation system of claim 14, wherein said flat screen display panel further comprises a membrane control pad.

16. The desktop-type ventilation system of claim 14, further comprising an interactive system capable of operating software to assist in instruction and completion of tasks.

17. The desktop-type ventilation system of claim 12, further comprising a work tray detachably connected to said ventilation hub.

18. The desktop-type ventilation system of claim 12, further comprising an adjustable spacer wall detachably connected to said side wall.

19. The desktop-type ventilation system of claim 12, wherein said ventilation hub further comprises at least one adjustable track wherein said side walls and said top wall are adjustably connected to said ventilation hub.

20. A desktop-type ventilation system of claim 12, further comprising an accessory storage device, wherein said accessory storage device is adjustable vertically in said fume hood.
